(19) United States
(12) Patent Application Publication
(10) Pub. No.: US 2020/0212566 A1
(43) Pub. Date: Jul. 2, 2020

(54) DUAL BAND BEAM GENERATOR

(71) Applicant: INDUSTRIAL TECHNOLOGY RESEARCH INSTITUTE, Hsinchu (TW)

(72) Inventors: Zuo-Min TSAI, Miaoli City (TW); Yen-Heng Lin, Tainan (TW)

(21) Appl. No.: 16/233,362

(22) Filed: Dec. 27, 2018

(51) Int. Cl. H01Q 3/40; H01Q 1/24; H01Q 3/26; H04B 1/40; H01Q 25/00

(52) U.S. Cl. CPC H01Q 3/40; H01Q 1/246; H01Q 25/00; H04B 1/40; H01Q 3/2658

(57) ABSTRACT

A dual band beam generator comprises a Butler matrix, two first phase shifter and two second phase shifter. The Butler matrix includes first to eighth transceiver ports, the first to fourth transceiver ports are disposed at one side of the Butler matrix, and the fifth to eighth transceiver ports are disposed at an opposite side of the Butler matrix, two first ports of the two first phase shifters are respectively connected to the fifth and eighth transceiver ports of the Butler matrix, and two first ports of the two second phase shifters are respectively connected to the sixth and seventh transceiver ports of the Butler matrix.

### BACKGROUND

### 1. Technical Field

This disclosure relates to a beam generator, especially for a dual band beam generator.

### 2. Related Art

Since users' demands for a transmission speed of a mobile communication is increasing day by day, 4G mobile communication technology is no longer sufficient and 5G mobile communication technology must be developed. At present, 5G mobile communication technology should have different frequency bands corresponding to different country's setting, so the dual band application will be a future trend of the mobile communication application. When a frequency of an electromagnetic wave is higher, the energy of the electromagnetic wave is lost more easily when the electromagnetic wave is transmitted in the air. In order to reducing the loss of energy, some researchers have proposed some beam generators that can transmit electromagnetic waves through beams to reduce energy loss.

At present, a common beam generator can be made by a phase array or a Butler matrix. Since the hardware architecture of the phase array is complicated, the cost for manufacturing the phase array is more expensive and a user may not control the phase array easily. In order to achieving the dual-band application, two sets of the phase arrays must be used to make a beam generator. On the contrary, the hardware architecture of the Butler matrix is simpler than that of the phase array. For generating beams of two frequency bands at the same angle, intervals between antennas must be changed, so it is difficult to design the beam generator.

Therefore, there is indeed a need for an improved dual band beam generator, which can at least improve the above disadvantages.

### SUMMARY

Accordingly, this disclosure provides a dual band beam generator, two frequency bands can generate at the same output angle by a Butler matrix and phase shift controls.

According to one or more embodiment of this disclosure, a dual band beam generator is provided. The dual band beam generator comprises a Butler matrix, two first phase shifters and two second phase shifters. The Butler matrix includes first to eighth transceiver ports, the first to fourth transceiver ports are disposed at one side of the Butler matrix, and the fifth to eighth transceiver ports are disposed at an opposite side of the Butler matrix. Two first ports of the first phase shifters are respectively connected to the fifth and eighth transceiver ports of the Butler matrix, and the first phase shifters have different phase shifts when the first phase shifter works in different frequency bands. Two first ports of the second phase shifters are respectively connected to the sixth and seventh transceiver ports of the Butler matrix, and the second phase shifters have different phase shifts when the second phase shifter works in different frequency bands.

### BRIEF DESCRIPTION OF THE DRAWINGS

The present disclosure will become more fully understood from the detailed description given herein below and the accompanying drawings which are given by way of illustration only and thus are not limitative of the present disclosure and wherein:

FIG. 1 is a functional block diagram of a dual band multi-beam system according to an embodiment of the present disclosure;

FIG. 2 is a hardware architecture of a dual band beam generator of FIG. 1 according to an embodiment of the present disclosure;

FIG. 3 is a functional block diagram of a dual band single-beam system according to an embodiment of the present disclosure;

FIG. 4 is hardware architecture of a dual band beam generator of FIG. 3 according to an embodiment of the present disclosure;

FIG. 5 is a hardware architecture of a dual band beam generator of FIG. 3 according to another embodiment of the present disclosure; and

FIGS. 6A and 6B are diagrams showing a relationship between a array factor of a dual band beam generator and an output angle of a dual band beam generator according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

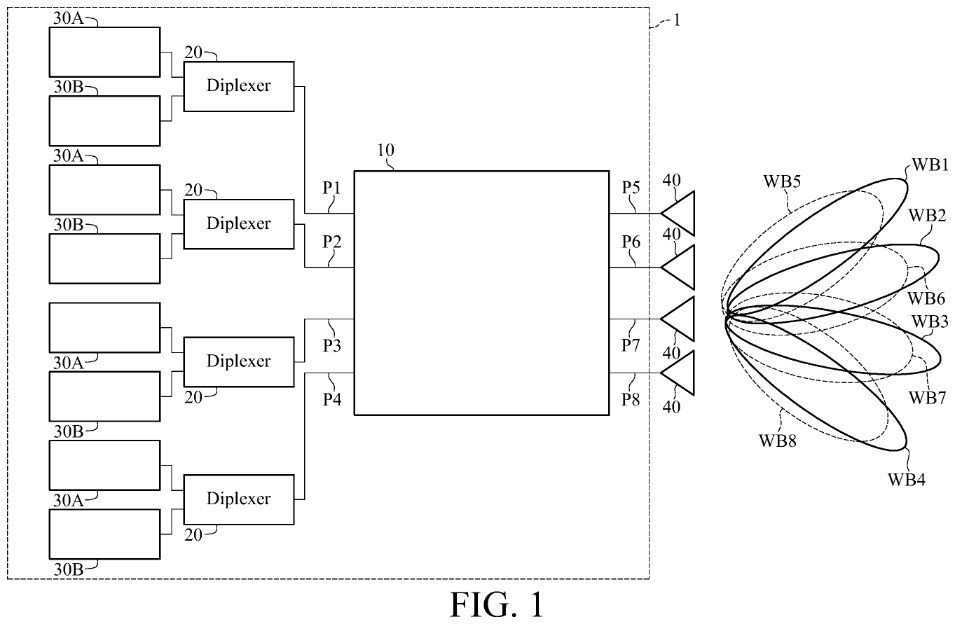

Please refer to FIG. 1 which is a functional block diagram of a dual band multi-beam system according to an embodiment of the present disclosure. The dual band multi-beam system 1 comprises a dual band beam generator 10, four diplexers 20, four transceivers 30A and four transceivers 30B, and the dual band beam generator 10 has a first port P1, a second port P2, a third port P3 and a fourth port P4. The first port P1, the second port P2, the third port P3, and the fourth port P4 are electrically connected to the four diplexers 20 respectively. The dual band beam generator 10 further has a fifth port P5, a sixth port P6, a seventh port P7 and an eighth port P8. The fifth port P5, the sixth port P6, the seventh port P7, and the eighth port P8 are electrically connected to four antennas 40 respectively, and an interval (d) between the fifth port P5 and the sixth port P6, an interval between the sixth port P6 and the seventh port P7, and an interval between the seventh port P7 and the eighth port P8 are the same. Wherein antennas 40 can be dual band antennas. In one embodiment, the interval (d) is 0.5 times a wavelength of a signal having a higher frequency in the dual frequency band. The first port P1, the second port P2, the third port P3, and the fourth port P4 respectively correspond to different beams.

The dual band multi-beam system 1 can be switched between a transmitting state and a receiving state. When the dual band multi-beam system 1 is in the transmitting state, the first to fourth ports P1 to P4 serve as signal input ports, and the fifth to eighth ports P5 to P8 serve as signal output ports. When the dual band multi-beam system 1 is in the receiving state, the first to fourth ports P1 to P4 serve as signal output ports, and the fifth to eighth ports P5 to P8 serve as signal input ports.

The transceiver 30A processes a first frequency band signal, and the transceiver 30B processes a second frequency band signal. When the transceivers 30A and 30B output high frequency signals having different frequencies respectively, each of the diplexers 20 receives two types of the high frequency signals and transmitted the high frequency signals to corresponding ports of the dual band beam generator 10, and then the dual band beam generator 10 processes the high frequency signals with a specific phase delay. After processing the high frequency signals with the specific phase delay, the dual band beam generator 10 transmits the high frequency signals to the air by the antennas 40, and the electromagnetic waves can form fifth to eighth beams WB5˜WB8 having first frequencies respectively in a first frequency band and first to fourth beams WB1˜WB4 having second frequencies respectively in a second frequency band in the air. Wherein an output angle of the first beam WB1 and an output angle of the fifth beam WB5 are the same, an output angle of the second beam WB2 and an output angle of the sixth beam WB6 are the same, an output angle of the third beam WB3 and an output angle of the seventh beam WB7 are the same, and an output angle of the fourth beam WB4 and an output angle of the eighth beam WB8 are the same.

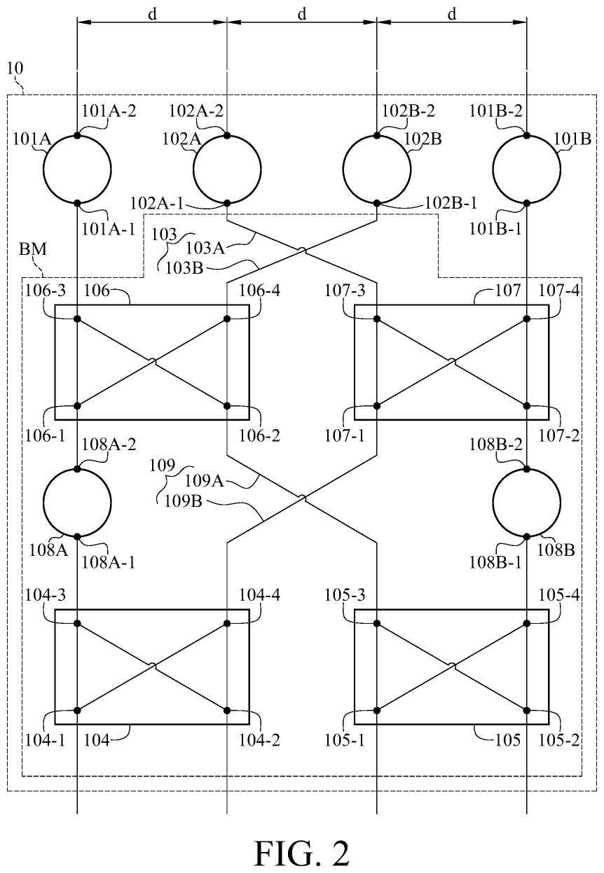

FIG. 2 is a hardware architecture of a dual band beam generator of FIG. 1 according to an embodiment of the present disclosure. Please refer to FIG. 1 and FIG. 2 together, the dual band beam generator 10 can comprise a Butler matrix BM, two first phase shifters 101A and 101B, and two second phase shifters 102A and 102B. The Butler matrix BM has first to eighth transceiver ports, the first to fourth transceiver ports are disposed at one side of the Butler matrix BM, and the fifth to eighth transceiver ports are disposed at an opposite side of the Butler matrix BM. The first to fourth transceiver ports of the Butler matrix BM are the first to fourth ports P1 to P4 of the dual band beam generator 10 respectively. The fifth transceiver port of the Butler matrix BM and the eighth transceiver port of the Butler matrix BM are respectively connect to a first port 101A-1 of the first phase shifter 101A and a first port 101B-1 of the first phase shifter 101B, wherein each of the first phase shifters 101A and 101B has different phase shifts in different frequency bands, the sixth transceiver port of the Butler matrix BM and the seventh transceiver port of the Butler matrix BM are respectively connected to a first port 102A-1 of the second phase shifter 102A and a first port 102B-1 of the second phase shifter 102B, wherein each of the second phase shifters 102A and 102B has different phase shifts (in) different frequency bands.

The Butler matrix BM further comprises a first coupler 104, a second coupler 105, a third coupler 106, a fourth coupler 107, two third phase shifters 108A and 108B, a first crossover 103 and a second crossover 109, wherein phase shifts of the third phase shifters 108A and 108B are different from phase shifts of the first phase shifters 101A and 101B, and the phase shifts of the third phase shifters 108A and 108B are different from phase shifts of the second phase shifters 102A and 102B. In an embodiment, the first coupler 104, the second coupler 105, the third coupler 106 and the fourth coupler 107 may be quadrature couplers, which generally divide a signal into two signals, wherein the two signals generated by the quadrature coupler have the same power and a phase difference between the two signals is 90 degrees.

A first port 104-1 of the first coupler 104 is the first port P1 of the dual band beam generator 10 and a second port 104-2 of the first coupler 104 is the second port P2 of the dual band beam generator 10. A first port 105-1 of the second coupler 105 is the third port P3 of the dual band beam generator 10 and a second port 105-2 of the second coupler 105 is the fourth port P4 of the dual band beam generator 10, that is, the first transceiver port of the Butler matrix BM and the second transceiver port of the Butler matrix BM are disposed at the first coupler 104, and the third transceiver port of the Butler matrix BM and the fourth transceiver port of the Butler matrix BM are disposed at the second coupler 105. The second crossover 109 includes two conductive wires 109A and 109B that intersect each other and are not electrically connected to each other. A third port 104-3 of the first coupler 104 is electrically connected to a first port 108A-1 of the third phase shifter 108A and a fourth port 104-4 of the first coupler 104 is electrically connected to one end of the conductive wire 109B. A third port 105-3 of the second coupler 105 is electrically connected to one end of the conductive wire 109A and a fourth port 105-4 of the second coupler 105 is electrically connected to a first port 108B-1 of the third phase shifter 108B.

A first port 106-1 of the third coupler 106 is electrically connected to a second port 108A-2 of the third phase shifter 108A and a second port 106-2 of the third coupler 106 is electrically connected to the other end of the conductive wire 109A. A first port 107-1 of the fourth coupler 107 is electrically connected to the other end of the conductive wire 109B and a second port 107-2 of the fourth coupler 107 is electrically connected to a second port 108B-2 of the third phase shifter 108B, that is, the third phase shifter 108A is connected between the first coupler 104 and the third coupler 106, and the third phase shifter 108B is connected between the second coupler 105 and the fourth coupler 107. The first coupler 104 is electrically connected to the fourth coupler 107 by the second crossover 109, and the second coupler 105 is electrically connected to the third coupler 106 by the second crossover 109.

The first crossover 103 includes two conductive wires 103A and 103B that intersect each other and are not electrically connected to each other. A third port 106-3 of the third coupler 106 is electrically connected to a first port 101A-1 of the first phase shifter 101A and a fourth port 106-4 of the third coupler 106 is electrically connected to one end of the conductive wire 103B. The other end of the conductive wire 103B is electrically connected to a first port 102B-1 of the second phase shifter 102B. A third port 107-3 of the fourth coupler 107 is electrically connected to one end of the conductive wire 103A and a fourth port 107-4 of the fourth coupler 107 is electrically connected to a first port 101B-1 of the first phase shifter 101B. The other end of the conductive wire 103A is electrically connected to a first port 102A-1 of the second phase shifter 102A. The third port 106-3 of the third coupler 106 is the fifth transceiver port of the Butler matrix BM; the end of the conductive wire 103B which is electrically connected to the second phase shifter 102B is the seventh transceiver port of the Butler matrix BM, wherein the seventh transceiver port is electrically connected to the second phase shifter 102B by the conductive wire 103B. The end of the conductive wire 103A which is electrically connected to the second phase shifter 102A is the sixth transceiver port of the Butler matrix BM, wherein the sixth transceiver port is electrically connected to the second phase shifter 102A by the conductive wire 103A. The fourth port 107-4 of the fourth coupler 107 is the eighth transceiver port of the Butler matrix BM. An interval (d) between the fifth transceiver port and the sixth transceiver port of the Butler matrix BM, an interval (d) between the sixth transceiver port and the seventh transceiver port of the Butler matrix BM, and an interval (d) between the seventh transceiver port and the eighth transceiver port of the Butler matrix BM are the same. A second port 101A-2 of the first phase shifter 101A is the fifth port P5 of the dual band beam generator 10, a second port 102A-2 of the second phase shifter 102A is the sixth port P6 of the dual band beam generator 10, a second port 102B-2 of the second phase shifter 102B is the seventh port P7 of the dual band beam generator 10, and a second port 101B-2 of the first phase shifter 101B is the eighth transceiver port of the dual band beam generator 10. The second port 101A-2 of the first phase shifter 101A, the second port 102A-2 of the second phase shifter 102A, the second port 102B-2 of the second phase shifter 102B and the second port 101B-2 of the first phase shifter 101B are electrically connected to the four antennas 40 respectively. Intervals, with each interval between any two adjacent antennas 40, are the same.

The dual band beam generator 10 can be switched between a transmitting state and a receiving state. When the dual band beam generator 10 is in the transmitting state, the first port 101A-1 of the first phase shifter 101A, the first port 101B-1 of the first phase shifter 101B, the first port 102A-1 of the second phase shifter 102A, the first port 102B-1 of the second phase shifter 102B, the first port 104-1 of the first coupler 104, the second port 104-2 of the first coupler 104, the first port 105-1 of the second coupler 105, the second port 105-2 of the second coupler 105, the first port 106-1 of the third coupler 106, the second port 106-2 of the third coupler 106, the first port 107-1 of the fourth coupler 107, the second port 107-2 of the fourth coupler 107, the first port 108A-1 of the third phase shifter 108A and the first port 108B-1 of the third phase shifter 108B serve as signal input ports. The second port 101A-2 of the first phase shifter 101A, the second port 101B-2 of the first phase shifter 101B, the second port 102A-2 of the second phase shifter 102A, the second port 102B-2 of the second phase shifter 102B, the third port 104-3 of the first coupler 104, the fourth port 104-4 of the first coupler 104, the third port 105-3 of the second coupler 105, the fourth port 105-4 of the second coupler 105, the third port 106-3 of the third coupler 106, the fourth port 106-4 of the third coupler 106, the third port 107-3 of the fourth coupler 107, the fourth port 107-4 of the fourth coupler 107, the second port 108A-2 of the third phase shifter 108A and the second port 108B-2 of the third phase shifter 108B serve as signal output ports. Similarly, when the dual band beam generator 10 is in the receiving state, the signal input ports and the signal output ends according to the receiving state are defined just opposite to those according to the transmitting state.

The first to fourth ports P1 to P4 of the dual band multi-beam system 1 can receive a 2.9 GHz-signal which is in a first frequency band and a 5.8 GHz-signal which is in a second frequency band. When the operating frequency of the dual band multi-beam system 1 is at 2.9 GHz, the phase shifts of the first phase shifters 101A and 101B are set as 90 degrees respectively, the phase shifts of the second phase shifters 102A and 102B are set as minus 90 degrees respectively, and the phase shifts of the third phase shifters 108A and 108B are set as minus 45 degrees respectively. When the operating frequency of the dual band multi-beam system 1 is at 5.8 GHz, the phase shifts of the first phase shifters 101A and 101B are set as 135 degrees respectively, the phase shifts of the second phase shifters 102A and 102B are set as 135 degrees respectively, and the phase shifts of the third phase shifters 108A and 108B are set as minus 45 degrees respectively. After the 2.9 GHz-signal and the 5.8 GHz-signal are inputted into the first port P1, the dual band beam generator 10 firstly performs specific phase delays for the 2.9 GHz-signal and the 5.8 GHz-signal respectively, and then the 2.9 GHz-signal and the 5.8 GHz-signal are transmitted by the four antennas 40 so as to form a 2.9 GHz-fifth beam WB5 and a 5.8 GHz-third beam WB3 in the air. After the 2.9 GHz-signal and the 5.8 GHz-signal are inputted into the second port P2, the dual band beam generator 10 firstly performs specific phase delays for the 2.9 GHz-signal and the 5.8 GHz-signal respectively, and then the 2.9 GHz-signal and the 5.8 GHz-signal are transmitted by the four antennas 40 so as to form a 2.9 GHz-sixth beam WB6 and a 5.8 GHz-first beam WB1 in the air. After the 2.9 GHz-signal and the 5.8 GHz-signal are inputted into the third port P3, the dual band beam generator 10 firstly performs specific phase delays for the 2.9 GHz-signal and the 5.8 GHz-signal respectively, and then the 2.9 GHz-signal and the 5.8 GHz-signal are transmitted by the four antennas 40 so as to form a 2.9 GHz-seventh beam WB7 and a 5.8 GHz-fourth beam WB4 in the air. After the 2.9 GHz-signal and the 5.8 GHz-signal are inputted into the fourth port P4, the dual band beam generator 10 firstly performs specific phase delays for the 2.9 GHz-signal and the 5.8 GHz-signal respectively, and then the 2.9 GHz-signal and the 5.8 GHz-signal are transmitted by the four antennas 40 so as to form a 2.9 GHz-eighth beam WB8 and a 5.8 GHz-second beam WB2 in the air. In this way, the dual band beam generator 10 can transmit 2.9 GHz-beams and 5.8 GHz-beams to the air.

In another embodiment, the dual band multi-beam system 1 can receive a 29 GHz-signal and a 58 GHz-signals. when the operating frequency of dual band multi-beam system 1 is at 29 GHz, the phase shifts of the two first phase shifters 101A and 101B are set at 90 degrees respectively. The phase shifts of the two second phase shifters 102A and 102B are set as minus 90 degrees respectively, and the phase shifts of the third phase shifters 108A and 108B are set as minus 45 degrees respectively. When the operating frequency of dual band multi-beam system 1 is at 58 GHz, the phase shifts of the two first phase shifters 101A and 101B are set as 135 degrees respectively, the phase shifts of the two second phase shifters 102A and 102B are set as 135 degrees respectively, and the phase shifts of the third phase shifters 108A and 108B are set as minus 45 degrees respectively.

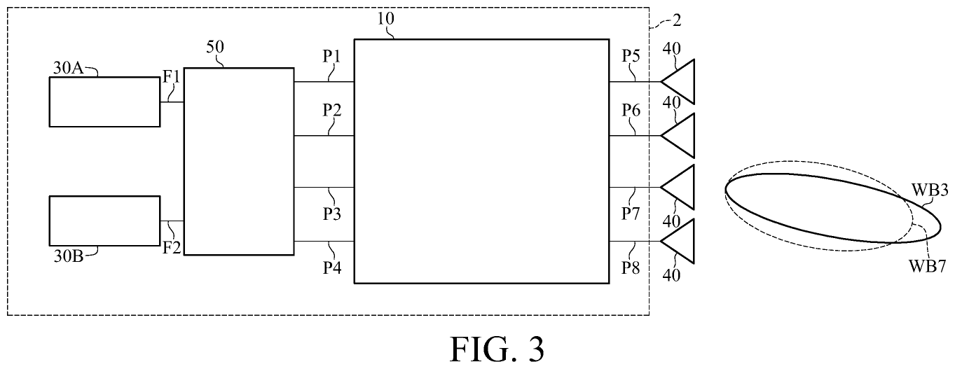

FIG. 3 is a functional block diagram of a dual band single-beam system according to an embodiment of the present disclosure. As shown in FIG. 3, a dual band single-beam system 2 comprises the dual band beam generator 10, a switch circuit 50 and two transceivers 30A and 30B. The fifth to eighth ports P5-P8 of the dual band beam generator 10 are electrically connected to the four antennas 40 respectively, and the interval (d) between the fifth port P5 and the sixth port P6, the interval between the sixth port P6 and the seventh port P7, and the interval between the seventh port P7 and the eighth port P8 are the same. In this embodiment, the antennas 40 can be dual band antennas. In one embodiment, the interval (d) is 0.5 times a wavelength of a signal having a higher frequency in the dual frequency band. The first to fourth ports P1 to P4 of the dual band beam generator 10 are electrically connected to four ports of the switch circuit 50 respectively, and two ports F1 and F2 disposed at an opposite side of the switch circuit 50 are electrically connected to the two transceivers 30A and 30B respectively. The dual band single-beam system 2 can be switched between a transmitting state and a receiving state. When the dual band single-beam system 2 is in the transmitting state, the two ports F1 and F2 of the switch circuit 50 serve as signal input ports respectively. Conversely, when the dual band single-beam system 2 is in the receiving state, the two ports F1 and F2 of the switch 50 circuit serve as signal output ports respectively.

When the dual band single-beam system 2 is in the transmitting state, the port F1 of the transceiver 30A outputs a first frequency signal which is in a first frequency band, and the port F2 of the transceiver 30B outputs a second frequency signal which is in a second frequency band. Then the switch circuit 50 receives the first frequency signal and the second frequency signal. The first frequency signal and the second frequency signal are respectively transmitted to two of the signal input ports of the dual band beam generator 10 via two of signal output ports of the switch circuit 50. Then the dual band beam generator 10 performs specific phase delays for the first frequency signal and the second frequency signal respectively, and then transmits the first frequency signal and the second frequency signal by the four antennas 40 respectively, so that the electromagnetic waves with two different frequencies can form the third beam WB3 and the seventh beam WB 7 in the air, wherein the angle of the third beam WB3 and the angle of the seventh beam WB7 are the same.

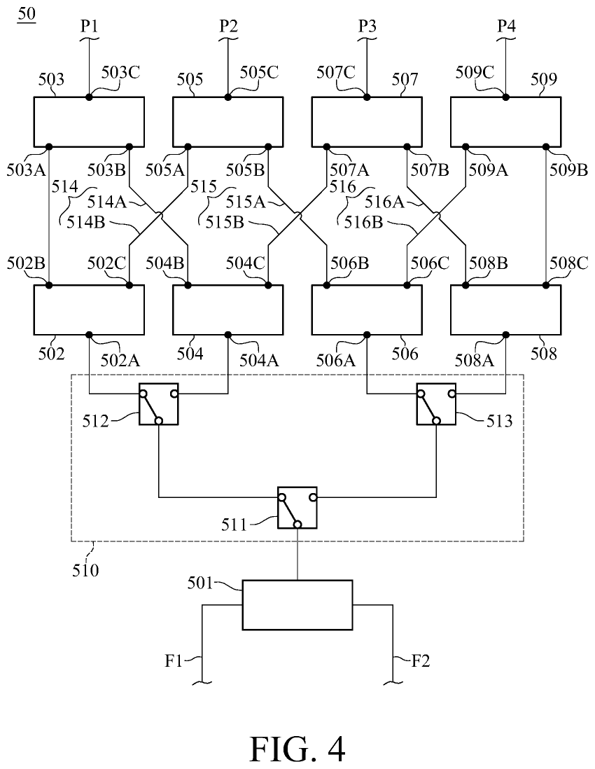

FIG. 4 is hardware architecture of a dual band beam generator of FIG. 3 according to an embodiment of the present disclosure. In the following disclosure, the dual band beam generator is in the transmitting state as an example. When the dual band beam generator is switched to the receiving state, the definitions of the output ports, the definitions of the input ports, definitions of input nodes, and definitions of output nodes according to the receiving state are opposite to those according to the transmitting state. Please refer to FIG. 2, FIG. 3 and FIG. 4 together, the switch circuit 50 may include first to ninth diplexers 501 to 509 and a switch device 510. The switch device 510 includes first to third switches 511 to 513, and each of the switches 511 to 513 has one input node and two output nodes. The two ports F1 and F2 of the switch circuit 50 are two input ports of the first diplexer 501 respectively, and an output port of the first diplexer 501 is connected to an input node of the first switch 511. Two output nodes of the first switch 511 are respectively connected to an input node of the second switch 512 and an input node of the third switch 513, that is, the first switch 511 is connected to the first diplexer 501, the second switch 512 and the third switch 513. Two output nodes of the second switch 512 are respectively connected to an input end 502A of the second diplexer 502 and an input end 504A of the fourth diplexer 504, and two output nodes of the third switch 513 are respectively connected to an input port 506A of the sixth diplexer 506 and an input port 508A of the eighth diplexer 508.

The switch circuit 50 also includes a third crossover 514, a fourth crossover 515 and a fifth crossover 516, wherein the third crossover 514 includes two conductive wires 514A and 514B, the fourth crossover 515 includes two conductive wires 515A and 515B, and the fifth crossover 516 includes two conductive wires 516A and 516B. Two output ports 502B and 502C of the second diplexer 502 are electrically connected to an input port 503A of the third diplexer 503 and one end of the conductive wire 514B respectively, and the other end of the conductive wire 514B is connected to an input port 505A of the fifth diplexer 505. Two output ports 504B and 504C of the fourth diplexer 504 are electrically connected to one end of the conductive wire 514A and one end of the conductive wire 515B respectively, and the other end of the conductive wire 514A is connected to an input port 503B of the third diplexer 503 and the other end of the conductive wire 515B is connected an input port 507A of seventh diplexer 507. Two output ports 506B and 506C of the sixth diplexer 506 are electrically connected to one end of the conductive wire 515A and one end of the conductive wire 516B respectively, and the other end of the conductive wire 515A is connected to an input port 505B of the fifth diplexer 505 and the other end of the conductive wire 516B is connected to an input port 509A of ninth diplexer 509. Two output ends 508B and 508C of the eighth diplexer 508 are electrically connected to one end of the conductive wire 516A and an input port 509B of the ninth diplexer 509 respectively. In summary, the second diplexer 502 and the fourth diplexer 504 are respectively connected to the fifth diplexer 505 and the third diplexer 503 by the third crossover 514. The fourth diplexer 504 and the sixth diplexer 506 are respectively connected to the seventh diplexer 507 and the fifth diplexer 505 by the fourth crossover 515. The sixth diplexer 506 and the eighth diplexer 508 are respectively connected to the ninth diplexer 509 and the seventh diplexer 507 by the fifth crossover 516. The other end of the conductive wire 516A is connected to the input port 507B of the seventh diplexer 507. An output port 503C of the third diplexer 503 is connected to the first port P1 of the dual band beam generator 10, an output port 505C of the fifth diplexer 505 is connected to the second port P2 of the dual band beam generator 10, an output port 507C of the seventh diplexer 507 is connected to the third port P3 of the dual band beam generator 10, and the output port 509C of the ninth diplexer 509 is connected to the fourth port P4 of the dual band beam generator 10.

Users can determine output angles of beams by configuring states of the switch device 510. In this embodiment, the switch device 510 can have first to fourth states. For example, after the two input ports of the first diplexer 501 receives a 2.9 GHz-signal which is in a first frequency band and a 5.8 GHz-signal which is in a second frequency band respectively, the users can configure the switch device 510 to be in a first state. When the switch device 510 is in the first state, the input node of the first switch 511 is connected to the output node of the first switch 511 on the left side, and the input node of the second switch 512 is connected to the output node of the second switch 512 on the left side, so that the 2.9 GHz-signal and the 5.8 GHz-signal are transmitted to the input port 502A of the second diplexer 502. Then the 2.9 GHz-signal and the 5.8 GHz-signal are respectively transmitted to the input port 503A of the third diplexer 503 and the input port 505A of the fifth diplexer 505 by the two output ports 502B and 502C of the second diplexer 502. Then the 2.9 GHz-signal and the 5.8 GHz-signal are respectively transmitted to the first port P1 of the dual band beam generator 10 and the second port P2 of the dual band beam generator 10 by the output port 503C of the third diplexer 503 and the output port 505C of the fifth diplexer 505. The dual band beam generator 10 firstly processes specific phase delays for the 2.9 GHz-signal and the 5.8 GHz-signal, and then transmits the 2.9 GHz-signal and the 5.8 GHz-signal by the four antennas 40 respectively, so that those electromagnetic waves can form the 2.9 GHz-fifth beam WB5 and the 5.8 GHz-first beam WB1 in the air, wherein the angle of the 2.9 GHz-fifth beam WB5 and the angle of the 5.8 GHz-first beam WB1 are the same.

When the switch device 510 is in the second state, the input node of the first switch 511 is connected to the output node of the first switch 511 on the right side, and the input node of the third switch 513 is connected to the output node of the third switch 513 on the left side, so that the 2.9 GHz-signal and the 5.8 GHz-signal are transmitted to the input port 506A of the sixth diplexer 506. Then the 2.9 GHz-signal and the 5.8 GHz-signal are respectively transmitted to the input port 505B of the fifth diplexer 505 and the input port 509A of the ninth diplexer 509 by the two output ports 506B and 506C of the sixth diplexer 506. Then the 2.9 GHz-signal and the 5.8 GHz-signal are respectively transmitted to the second port P2 of the dual band beam generator 10 and the fourth port P4 of the dual band beam generator 10 by the output port 505C of the fifth diplexer 505 and the output port 509C of the ninth diplexer 509. The dual band beam generator 10 firstly processes specific phase delays for the 2.9 GHz-signal and the 5.8 GHz-signal, and then transmits the 2.9 GHz-signal and the 5.8 GHz-signal by the four antennas 40 respectively, so that those electromagnetic waves can form the 2.9 GHz-sixth beam WB6 and the 5.8 GHz-second beam WB2 in the air, wherein the angle of the 2.9 GHz-sixth beam WB6 and the angle of the 5.8 GHz-second beam WB2 are the same.

When the switch device 510 is in the third state, the input node of the first switch 511 is connected to the output node of the first switch 511 on the left side, and the input node of the second switch 512 is connected to the output node of the second switch 512 on the right side, so that the 2.9 GHz-signal and the 5.8 GHz-signal are transmitted to the input port 504A of the fourth diplexer 504. Then the 2.9 GHz-signal and the 5.8 GHz-signal are respectively transmitted to the input port 507A of the seventh diplexer 507 and the input port 503B of the fifth diplexer 505 by the two output ports 504C and 504B of the fourth diplexer 504. Then the 2.9 GHz-signal and the 5.8 GHz-signal are respectively transmitted to the third port P3 of the dual band beam generator 10 and the first port P1 of the dual band beam generator 10 by the output port 507C of the seventh diplexer 507 and the output port 503C of the third diplexer 503. The dual band beam generator 10 firstly processes specific phase delays for the 2.9 GHz-signal and the 5.8 GHz-signal, and then transmits the 2.9 GHz-signal and the 5.8 GHz-signal by the four antennas 40 respectively, so that those electromagnetic waves can form the 2.9 GHz-seventh beam WB7 and the 5.8 GHz-third beam WB3 in the air, wherein the angle of the 2.9 GHz-seventh beam WB7 and the angle of the 5.8 GHz-third beam WB3 are the same (refer to FIG. 3).

When the switch device 510 is in the fourth state, the input node of the first switch 511 is connected to the output node of the first switch 511 on the right side, and the input node of the third switch 513 is connected to the output node of the third switch 513 on the right side, so that the 2.9 GHz-signal and the 5.8 GHz-signal are transmitted to the input port 508A of the eighth diplexer 508. Then the 2.9 GHz-signal and the 5.8 GHz-signal are respectively transmitted to the input port 509B of the ninth diplexer 509 and the input port 507B of the seventh diplexer 507 by the two output ports 508C and 508B of the eighth diplexer 508. Then the 2.9 GHz-signal and the 5.8 GHz-signal are respectively transmitted to the fourth port P4 of the dual band beam generator 10 and the third port P3 of the dual band beam generator 10 by the output port 509C of the ninth diplexer 509 and the output port 507C of the seventh diplexer 507. The dual band beam generator 10 firstly processes specific phase delays for the 2.9 GHz-signal and the 5.8 GHz-signal, and then transmits the 2.9 GHz-signal and the 5.8 GHz-signal by the four antennas 40 respectively, so that those electromagnetic waves can form the 2.9 GHz-eighth beam WB8 and the 5.8 GHz-fourth beam WB4 in the air, wherein the angle of the 2.9 GHz-eighth beam WB8 and the angle of the 5.8 GHz-fourth beam WB4 are the same. The dual band beam generator 10 shown in FIGS. 3 and 4 is suitable for the case where the crowd gathers in a specific area, and a user can make the dual band beam generator 10 face the specific area so as to output two beams in two different frequency bands and a plurality of data to the specific area by switching the states of the switch device 510.

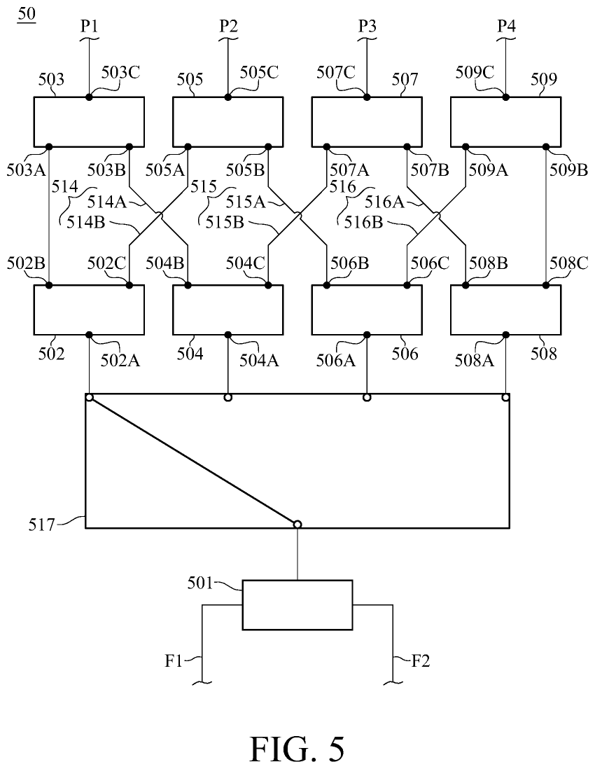

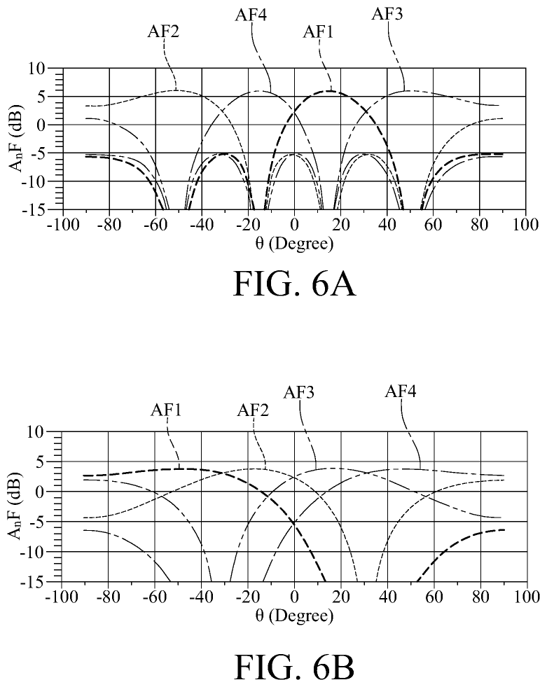

FIG. 5 is a hardware architecture of a dual band beam generator of FIG. 3 according to another embodiment of the present disclosure. In the following disclosure, the dual band beam generator is in the transmitting state as an example. When the dual band beam generator is switched to the receiving state, the definitions of the output ports, the definitions of the input ports, definitions of input nodes, and definitions of output nodes according to the receiving state are opposite to those according to the transmitting state. The difference between the embodiment of FIG. 4 and the embodiment of FIG. 5 is that the first switch 511, the second switch 512, and the third switch 513 shown in FIG. 4 are replaced with a four-paths switch 517. An input node of the four-paths switch 517 is connected to the output port of the first diplexer 501, and four output nodes of the four-paths switch 517 are respectively connected to the input port of the second duplexer 502, the input port of the fourth diplexer 504, the input port of the sixth diplexer 506 and the input port of the eighth diplexer 508. In this way, the user can change output angles of beams by configuring the four-paths switch 517, and the dual band beam generator can generate two beams having two different frequencies respectively at the same angle. FIG. 6A and FIG. 6B are diagrams showing a relationship between a array factor of a dual band beam generator and an output angle of a dual band beam generator according to an embodiment of the present disclosure simulated by ideal components.

FIG. 6A shows four output beams AF1˜AF4 with a second frequency, and FIG. 6B shows four output beams AF1˜AF4 with a first frequency, wherein the output angle of the beam AF2 of FIG. 6A is the same as that of the beam AF1 of FIG. 6B, the output angle of the beam AF4 of FIG. 6A is the same as that of the beam AF2 of FIG. 6B, the output angle of the beam AF1 of FIG. 6A is the same as that of the beam AF3 of FIG. 6B, and the output angle of the beam AF3 of FIG. 6A is the same as that of the beam AF4 of FIG. 6B. A circuit board is experimentally designed to measure the output angles of the beams outputted from the dual band beam generator of the present disclosure, wherein the measured output angles of the beams with the second frequency is substantially the same as the output angels of the beams in FIG. 6A, and the measured output angles of the beams with the first frequency is substantially the same as the output angels of the beams in FIG. 6B, and it can be known that the dual band beam generator of the present disclosure can generate two beams having two different frequencies respectively at the same output angle.

In view of the above description, the dual band beam generator comprising the Butler matrix and the two kinds of the phase shifters can generate multiple beams with two different frequencies when there are many people in a wide area, and the generated beams having two frequencies respectively can be transmitted at the same output angle, and the generated beams are simultaneously transmitted to the air along four output angles so as to transmit a large amount of data. When a crowd gathers in the specific area, the dual band beam generator only needs to output beams at a specific output angle, so the dual band beam generator can further comprise a switch circuit for generating two beams having two different frequencies respectively at the same output angle without changing the ports of the dual band beam generator corresponding to the two frequencies. Moreover, the hardware architecture of the dual band beam generator of the present disclosure is simpler than an active phase array system, so the dual band beam generator can have low production cost, be manufactured easily, and be controlled simply.

What is claimed is:

1. A dual band beam generator comprising:
a Butler matrix including first to eighth transceiver ports, the first to fourth transceiver ports disposed at one side of the Butler matrix, and the fifth to eighth transceiver ports disposed at an opposite side of the Butler matrix;
two first phase shifters, first port of each the two first phase shifters respectively connected to the fifth and eighth transceiver ports of the Butler matrix, with the first phase shifters having different phase shifts when the first phase shifter works in different frequency bands; and
two second phase shifters, first port of each the two second phase shifters respectively connected to the sixth and seventh transceiver ports of the Butler matrix, with the second phase shifters having different phase shifts when the second phase shifter works in different frequency bands.

2. The dual band beam generator in claim 1, wherein two beams which have two different frequencies and have the same angle correspond to two of the first to fourth transceiver ports of the Butler matrix respectively.

3. The dual band beam generator in claim 1, wherein second port of each the two first phase shifters and second port of each the two second phase shifters are connected to antennas respectively.

4. The dual band beam generator in claim 3, wherein an interval between the second port of the first phase shifter and the second port of the second phase is the same as an interval of the second ports of the second phase shifters.

5. The dual band beam generator in claim 1, wherein the Butler matrix further includes a first coupler, a second coupler, a third coupler, a fourth coupler, two third phase shifters, a first crossover and a second crossover, the first and second transceiver ports of the Butler matrix are disposed at the first coupler, the third and fourth transceiver ports of the Butler matrix are disposed at the second coupler, one of the third phase shifters is connected between the first coupler and the third coupler, another one of the third phase shifters is connected between the second coupler and the fourth coupler, the first coupler is electrically connected to the fourth coupler by the second crossover, the second coupler is electrically connected to the third coupler by the second crossover, one port of the third coupler is electrically connected to the first port of one of the first phase shifters, another one port of the third coupler is electrically connected to the first port of one of the second phase shifters by a first conductive wire of the first crossover, one port of the fourth coupler is electrically connected to the first port of another one of the second phase shifters by a second conductive wire of the first crossover, another port of the fourth coupler is electrically connected to the first port of another one of the first phase shifters,
the port of the third coupler electrically connected to one of the first phase shifters is regarded as the fifth transceiver port of the Butler matrix, one end of the first conductive wire of the first crossover electrically connected to one of the second phase shifters is regarded as the seventh transceiver port of the Butler matrix, the seventh transmitting port is electrically connected to the first port of one of the second phase shifters by the first conductive wire of the first crossover, one end of the second conductive wire of the first crossover electrically connected to another one of the second phase shifters is regarded as the sixth transceiver port of the Butler matrix, the sixth transmitting port is electrically connected to the first port of another one of the second phase shifters by the second conductive wire of the first crossover, the port of the fourth coupler electrically connected to one of the first phase shifters is regarded as the eighth transceiver port of the Butler matrix.

6. The dual band beam generator in claim 1, further comprising a switch circuit, the switch circuit includes a first diplexer, a switch device, a second diplexer, a third diplexer, a fourth diplexer, a fifth diplexer, a sixth diplexer, a seventh diplexer, an eighth diplexer and a ninth diplexer, wherein the first diplexer is connected to the switch device, the switch device is further connected to the second diplexer, the fourth diplexer, the sixth diplexer and the eighth diplexer, the second diplexer is further connected to the third diplexer and the fifth diplexer, the fourth diplexer is further connected to the third diplexer and the seventh diplexer, the sixth diplexer is further connected to the fifth diplexer and the ninth diplexer, the eighth diplexer is connected to the seventh diplexer and the ninth diplexer.

7. The dual band beam generator in claim 6, wherein the second diplexer and the fourth diplexer are respectively connected to the fifth diplexer and the third diplexer by a third crossover, the forth diplexer and the sixth diplexer are respectively connected to the seventh diplexer and the fifth diplexer by a fourth crossover, and the sixth diplexer and the eighth diplexer are respectively connected to the ninth diplexer and the seventh diplexer by a fifth crossover.

8. The dual band beam generator in claim 6, wherein the third diplexer, the fifth diplexer, the seventh diplexer and the ninth diplexer are respectively connected to the first to fourth transceiver port of the Butler matrix.

9. The dual band beam generator in claim 6, wherein the switch device includes a first switch, a second switch and a third switch, the first switch is connected to the first diplexer, the second switch and the third switch, the second switch is further connected to the second diplexer and the fourth diplexer, the third diplexer is further connected to the sixth diplexer and the eighth diplexer.

10. The dual band beam generator in claim 6, wherein the switch device is a four-paths switch, the four-paths switch is connected to the second diplexer, the fourth diplexer, the sixth diplexer and the eighth diplexer.
